(19) United States
(12) Patent Application Publication
(10) Pub. No.: US 2015/0271437 A1
(43) Pub. Date: Sep. 24, 2015

(54) Programmable interactive digital television system to record a primary channel while viewing the primary channel or viewing a secondary channel

(71) Applicants: Joseph M. Orlando, JR., Gloucester, MA (US); Zachary C. Lamkin, Middleton, MA (US)

(72) Inventors: Joseph M. Orlando, JR., Gloucester, MA (US); Zachary C. Lamkin, Middleton, MA (US)

(21) Appl. No.: 14/221,660

(22) Filed: Mar. 21, 2014

(51) Int. Cl. H04N 5/775; H04N 21/433

(52) U.S. Cl. CPC H04N 5/775; H04N 21/4334

(57) ABSTRACT

A novel means by which one video channel may be viewed, while recording it or another video channel, is herein described.

This utility application claims priority from Provisional Application 61/803,858 filed in the USPTO on 21 Mar. 2013, the content of which is incorporated in its entirety by reference into the instant application.

A programmable, interactive digital television system is provided with which a user may record a primary channel while viewing the primary channel or viewing one of any number of secondary channels. The secondary channel may be manually specified at the discretion of the viewer, or programmatically selected upon commencement of a commercial on the primary channel. The input signal to this watch-and-record system may come from any digital video signal source including but not limited to cable, satellite, and broadcast television. In the case of a programmatic selection of an alternative channel, the launch scheme information is stored in a memory and retrieved and executed upon the detection of a commercial being shown on the primary digital television channel.

Reversion to the primary channel upon termination of the commercial on the primary channel may be programmatically or manually controlled. These programmatic and manual channel selection techniques provide a very versatile watch-and-record environment for the user.

### DEFINITIONS

Primary digital television channel—the digital television channel being recorded by the viewer
Secondary digital television channel—the digital television channel programmatically or manually switched-to when the primary digital television channel begins showing a commercial
DVR—digital video recorder
Memory—digital data storage device

[THE COMPUTER CODE LISTING ORIGINALLY FILED AS PART OF THIS UTILITY APPLICATION HAS BEEN REMOVED AND FILED INDIVIDUALLY AS CODE.TXT]

### BRIEF DESCRIPTION OF THE DRAWINGS

FIG. 1 depicts an exemplary system for implementing various embodiments of the invention.

### DETAILED DESCRIPTION OF THE DRAWINGS

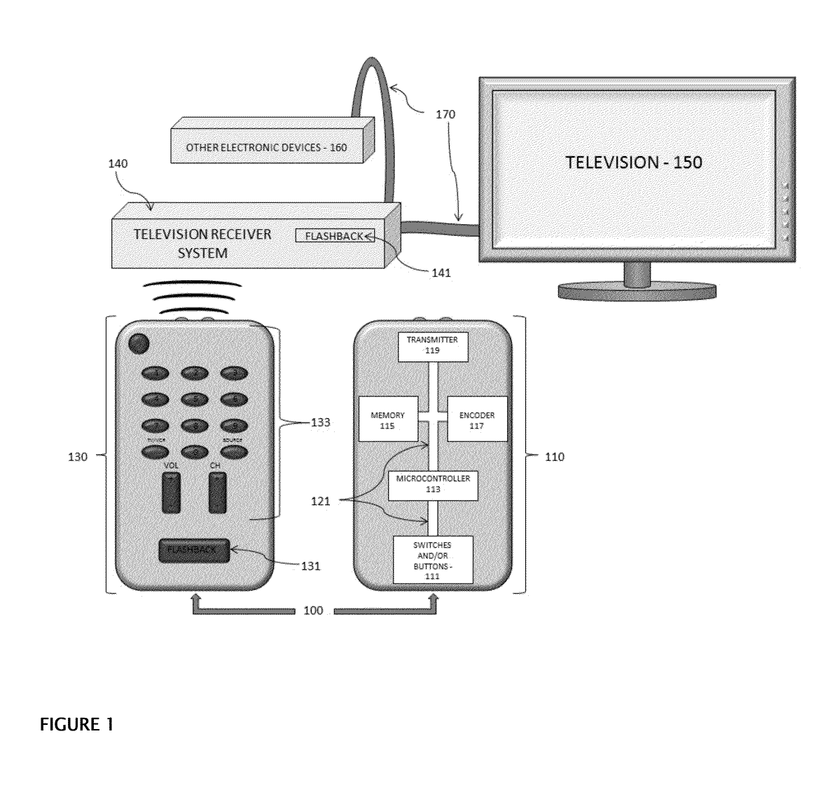

FIG. 1 depicts an exemplary rudimentary wireless remote controller 100 suitable for implementing various embodiments of the instant invention. The wireless remote controller typically includes, but is not limited to, switches and/or buttons 111, an encoder 117, a transmitter 119, a bus and/or wires to connect hardware 121, and a user interface 130. In accordance with some embodiments, the remote control 100 may contain a microprocessor 113 and memory 115 for storing and executing this invention's features, as well as other features available on the remote control. Other features include, but are not limited to volume up/down, channel up/down, guide, PIP, etc. The microprocessor 113 and memory 115 may even include the computer program, routine, or other logic which implements the features of this invention, as well as controlling features of other devices controlled by the same wireless remote control.

The user interface 130 contains an array of buttons 133 to control various aspects of the television receiver system 140, television 150, and other electronic devices 160. This array of buttons may include a specific button, which for the sake of this discussion is button 131, to enable or disable this invention's functionality. For example, while watching a television channel on the primary display of the television, the viewer may enable this invention's features by pressing button 131 and disable it by pressing this button again.

The array of buttons 133 on the user interface 130 directly correspond to the switches and/or buttons 111 on the printed circuit board (PCB) 110 or other electronic components located within the wireless remote controller 100. The switches and/or buttons 111 when pressed via the user interface will send a signal to the microprocessor 113. The microprocessor 113 will work with memory 115 to execute operations, if possible, as desired by user via switches and/or buttons 111.

Working in accordance with the microprocessor, the encoder 117 will encode and modulate signals to be ready for transmission. Encoding and modulating signals includes, but is not limited to, encoding bit patterns, modulating onto a carrier frequency, pulse-width modulation, amplitude modulation, etc. After being encoded, signals will be sent to a transmitter 119. The transmitter can send operations via radio frequency, infrared or any other means necessary for communication with television receiver system 140, television 150, or other electronic devices 160. The television receiver system 140, television 150, or other electronic devices 160 may interact with each other via cables or wireless connection 170.

In addition to being enabled and disabled by the wireless remote control, this invention may be similarly controlled by button 141, which may be located on the television receiver system 140 or any other system component.

What is claimed is:

1. A means by which the viewer of a primary digital television channel may:
a) view said primary television channel while recording it using DVR technology;
b) continue to record the primary channel during a commercial break on the primary channel while viewing the secondary digital television channel;
c) return to the primary channel or stay on said secondary channel while continuing to record the primary channel.

2. The means of viewing digital television of claim 1 further comprising a means by which the secondary channel is programmatically selected and switched-to automatically upon commencement of a commercial on the primary channel.

3. The means of viewing digital television of claim 1 further comprising a means by which reversion to the primary channel is programmatically executed upon termination of the commercial on the primary channel.

4. The means of viewing digital television of claim 1 further comprising a means by which the secondary channel is manually switched-to from the primary channel.

5. The means of viewing digital television of claim 1 further comprising a means by which reversion to the primary channel is manually executed by the viewer.
